(19) United States
(12) Patent Application Publication
(10) Pub. No.: US 2023/0274682 A1
(43) Pub. Date: Aug. 31, 2023

(54) DIGITAL GRAY CONTROL IN DISPLAY SYSTEMS

(71) Applicant: Meta Platforms Technologies, LLC, Menlo Park, CA (US)

(72) Inventor: Yun WANG, Bellevue, WA (US)

(73) Assignee: Meta Platforms Technologies, LLC, Menlo Park, CA (US)

(21) Appl. No.: 17/961,857

(22) Filed: Oct. 7, 2022

Related U.S. Application Data
(60) Provisional application No. 63/314,956, filed on Feb. 28, 2022.

(51) Int. Cl. G09G 3/20; G09G 3/3233

(52) U.S. Cl. CPC G09G 3/2007; G09G 3/3233; G09G 2300/0842; G09G 2330/021; G09G 2310/0286; G09G 2300/0857; G09G 2360/10; G09G 2310/0291; G09G 2310/08

(57) ABSTRACT

According to some examples, a display system may include control circuitry, power supply circuitry, and a pixel array. Each pixel in the pixel array may include a data shift register to receive gray level data for the pixel in series and to output the gray level data in parallel. Each pixel may also include a plurality of comparators, each comparator of the plurality of comparators to receive one bit of data from the data shift register and one bit of clock data, and a NOR gates sum circuit to provide a binary output based on outputs of all of the plurality of comparators. Each pixel may further include a flip flop circuit to provide a binary output based on the binary output of the NOR gates sum circuit, and an emissions circuit to emit light at a selected gray level based on the binary output of the flip flop circuit.

### CROSS REFERENCE TO RELATED APPLICATIONS

This patent application claims the benefit of U.S. Provisional Patent Application Ser. No. 63/314,956 filed on Feb. 28, 2022. The disclosures of the above application are hereby incorporated by reference for all purposes.

### TECHNICAL FIELD

This patent application relates generally to display systems, and more specifically, to display systems with a digital gray control backplane architecture that reduces power consumption without substantially increasing frame buffer size.

### BACKGROUND

With recent advances in technology, OLED based display systems, where an emissive electroluminescent layer is a film of organic compound that emits light in response to an electric current, have become common in devices such as television screens, computer monitors, and portable systems such as smartphones, VR devices, handheld game consoles, and smart watches. The organic layer is placed between two electrodes, at least one of which is transparent.

An OLED display emits visible light. Therefore, it can display deep black levels and can be thinner and lighter than a liquid crystal display (LCD). In low ambient light conditions, an OLED display can provide a higher contrast ratio than an LCD. Two types of backplanes employing analog driving method are commonly used to drive OLED displays. OLED displays used in phones, watches, or TVs are driven by thin film transistors (TFTs) fabricated on glass or flexible substrate, whereas OLED displays used in virtual reality (VR) headsets use complementary metal-oxide semiconductor (CMOS) backplane. Such OLED displays have a substantially smaller pixel pitch and are called microOLED. OLED or microOLED on silicon (OLEDoS) displays may have challenges with high power consumption, in addition to scalability with CMOS node and integration complexities.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of a computing device with a display, according to an example.

FIG. 2 illustrates various display devices, according to an example.

FIG. 3 is a block diagram of an OLED display, according to an example.

FIG. 4 illustrates a comparison of analog and digital gray control methods in various types of displays, according to an example.

FIG. 5 illustrates pixel circuitry and operation of analog gray control for driving OLED display pixels, according to an example.

FIG. 6 illustrates schematic representation of capacitances associated with each pixel of and an example representation of power consumption components in an OLED display, according to an example.

FIG. 7 illustrates a comparison of analog and digital gray control methods with respective pixel circuitry in OLED displays, according to an example.

FIG. 8 illustrates a driver architecture to implement digital gray control through storage of gray level data for each pixel, according to an example.

FIG. 9 illustrates a schematic block diagram of driver architecture for an OLED display pixel, according to an example.

FIG. 10A illustrates a first stage of pixel operation in an OLED display, where data is provided serially to a pixel shift register, according to an example.

FIG. 10B illustrates a second stage of pixel operation in an OLED display, where data bits are moved from latch to latch during each clock cycle while data is being written to each row of pixels, according to an example.

FIG. 10C illustrates a third stage of pixel operation in an OLED display, where data is compared to clock bit by bit in XOR comparators and an enable output is provided to a set/reset flip flop circuit if there is full match, according to an example.

FIG. 10D illustrates a fourth stage of pixel operation in an OLED display, where the set/reset flip flop circuit enables or disables the emission circuitry, according to an example.

FIG. 11 illustrates an alternative implementation, where display driver integrated circuit (DDIC) may be integrated to the CMOS backplane of an OLED display, according to an example.

FIG. 12 illustrates another alternative implementation, where a storage capacitor may be added to each pixel's drive circuitry but used with low charge time interval to reduce power consumption, according to an example.

FIG. 13 illustrates a further alternative implementation, where an enable signal may control shift registers and clock generators of groups of pixels by disabling gray control of pixels with black content, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Due to physical attributes (e.g., weight, flexibility, etc.) and display characteristics (e.g., resolution, refresh rate, contrast, brightness, etc.), OLED displays have become a popular type of display and are increasingly used in a variety of applications, such as, VR-based head-mounted devices, eyewear devices, and other wearable and portable systems. However, high power consumption is one of the challenges with OLED displays. For example, in a typical OLED display, more than one-third of power may be used on analog driving (also referred to as “analog gray control”) the OLED pixels in the backplane. The analog driving architecture applies different levels of control voltage to achieve a desired level of gray level in each pixel and requires a current-driven emitter device with a controllable current source and a storage capacitor for each pixel. This structure consumes a substantial amount of power and is difficult to scale with CMOS nodes of the display backplane. The CMOS circuits for the analog drivers are typically high voltage systems with slow subthreshold swing and therefore cannot be integrated with the remaining CMOS circuits of the OLED display.

Disclosed herein are systems, apparatuses, and methods that may provide OLED displays in which power consumption may be reduced through the use of digital pixel driving (also referred to as “digital gray control”). By using series-in and parallel-out data shift registers in columns and a bit-weighted frequency clock lines and a local comparator for each pixel, implementations according to examples may allow frame buffer to be minimized. The digital gray control may also allow use of advanced CMOS node, fully leveraging speed and/or smaller layout of advanced CMOS processes. Storage capacitors for each pixel may be removed in some examples, thereby avoiding charging of data lines. An output from driver IC may be directly used in the backplane without digital-to-analog conversion (DAC). Thus, power consumption of the backplane may be substantially reduced.

Furthermore, described architecture may be fully or partially compatible with standard CMOS processes. As a result, this may eliminate processing or device tuning for slow subthreshold swing and high voltage. Furthermore, the architecture may be scalable with future CMOS technology advancement. The systems and methods described herein may also allow integration of driver IC(s) and CMOS backplane into one IC, which may further reduce power consumption and/or render the module process more suitable to mass production. Other benefits and advantages may also be apparent.

Although examples described herein may be directed to OLED displays, it should be appreciated that the systems, apparatuses, methods described herein may also apply to any digital driving control display, including, but not limited to microLED, liquid-crystal on Si (LCOS), or other similar displays.

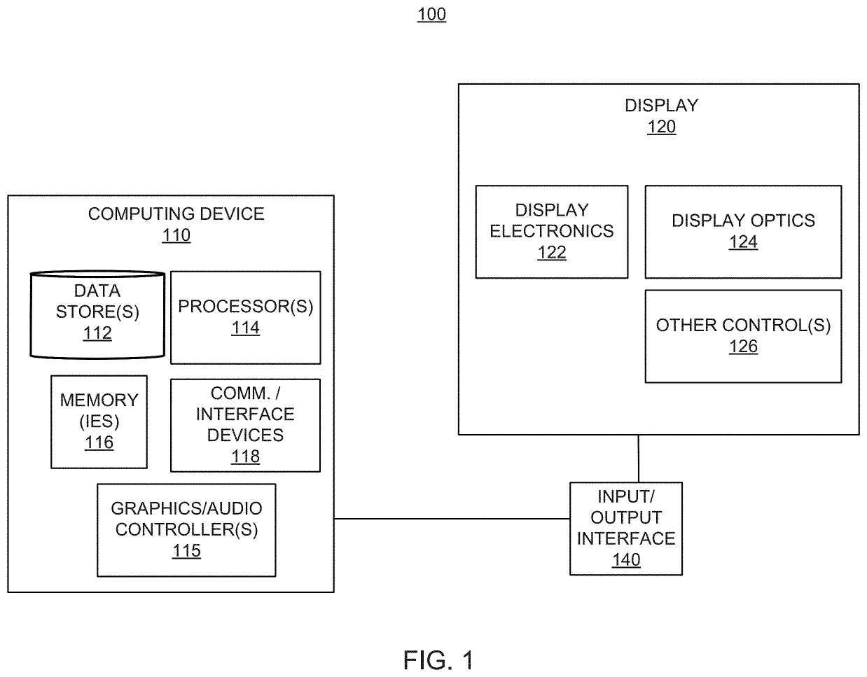

FIG. 1 illustrates a block diagram of a system environment 100 that includes a computing device with a display, according to an example. As used herein, a “display” may refer to a device that presents content (e.g., video, still images, three-dimensional images, etc.). As used herein, “an OLED display” may refer to display devices that use OLED technology and may be implemented in various shapes and forms. Such OLED displays may include use of technologies associated with virtual reality (VR), augmented reality (AR), and/or mixed reality (MR). As used herein a “user” may refer to a user observing a display or wearer of a “wearable OLED display.”

As shown in FIG. 1, the system environment 100 may include a computing device 110, a display 120, and an input/output interface 140 coupled between the computing device 110 and the display 120 to enable communication and data exchange between the two. The computing device 110 may include a number of components and sub-systems such as data storage(s) 112, processor(s) 114, memory(ies) 116, communication/interface devices 118, and graphics/audio controller(s) 115, among others. The display 120 may include display electronics 122, display optics 124, and other control(s) 126, among other things. In some examples, part or all of the computing device 110 may be integrated with the display 120.

In some instances, the computing device 110 may be any device capable of providing content to the displayed to the display 120 including, but not limited to, a desktop computer, a laptop computer, a portable computer, a wearable computer, a smart television, a server, a game console, a communication device, a monitoring device, or comparable devices. The computing device 110 may execute one or more applications, some of which may be associated with providing content to be displayed to the display 120. The applications (and other software) may be stored in data storage(s) 112 and/or memory(ies) 116 and executed by processor(s) 114. Communication/interface devices 118 may be used to receive input from other devices and/or human beings, and to provide output (e.g., instructions, data) to other devices such as the display 120. Graphics/audio controller(s) 115 may be used to process visual and audio data to be provided to output devices. For example, video or still images may be processed and provided to the display 120 through the graphics/audio controller(s) 115.

In some examples, the data store(s) 112 (and/or the memory(ies) 116) may include a non-transitory computer-readable storage medium storing instructions executable by the processor(s) 114. The processor(s) 114 may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the computing device 110 described in conjunction with FIG. 1 may be encoded as instructions in the non-transitory computer-readable storage medium that, when executed by the processor, may cause the processor to perform the functions further described below.

In some examples, the data storage(s) 112 may store one or more applications for execution by the computing device 110. An application may include a group of instructions that, when executed by a processor, generates content for presentation to the user. Examples of the applications may include gaming applications, conferencing applications, video playback application, or other suitable applications.

In some examples, the display 120 may be used to display content provided by the computing device 110 and may take many different shapes or forms. For example, the display 120 may be a desktop monitor, a wall-mount monitor, a portable monitor, a wearable monitor (e.g., VR or AR glasses), and comparable ones to name a few. The display 120 may include display electronics 122, display optics 124, and other control(s) 126.

In some examples, the display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

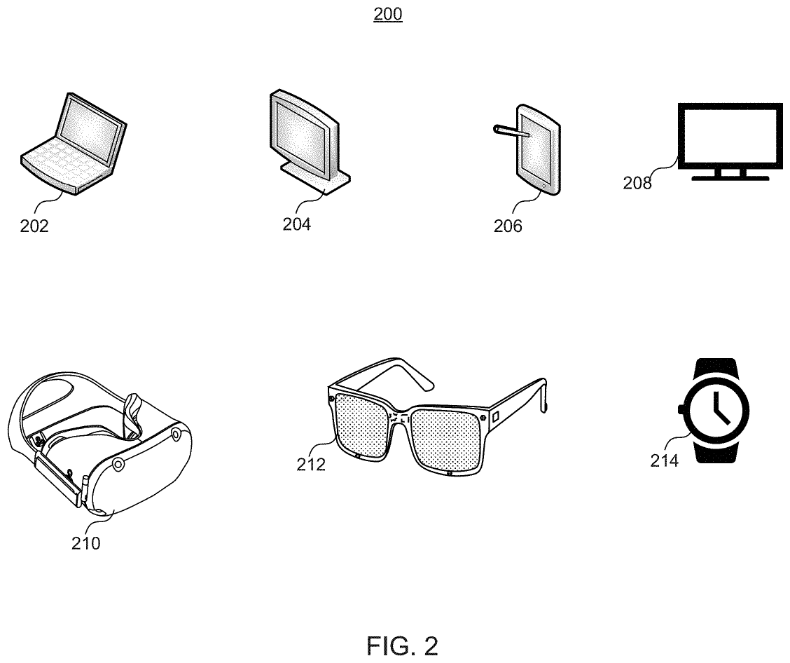

In some examples, the display 120 may be implemented in any suitable form-factor as mentioned above, including a head-mounted display, a pair of glasses, or other similar wearable eyewear or device. Examples of the display 120 are further described below with respect to FIG. 2. Additionally, in some examples, the functionality described herein may be used in a head-mounted display or headset that may combine images of an environment external to the display 120 and artificial reality content (e.g., computer-generated images). Therefore, in some examples, the display 120 may augment images of a physical, real-world environment external to the display 120 with generated and/or overlaid digital content (e.g., images, video, sound, etc.) to present an augmented reality to a user.

In some examples, the display electronics 122 may display or facilitate the display of images to the user according to data received from, for example, the computing device 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the display electronics 122 may include circuitry to provide power to the pixels, control behavior of the pixels, etc. Control circuitry, also referred to as “drivers” or “driving circuitry”, may control which pixels are activated, a desired gray level for each pixel in some examples.

In some examples, the display optics 124 may display image content optically (e.g., using optical waveguides and/or couplers) or magnify image light received from the display electronics 122, correct optical errors associated with the image light, and/or present the corrected image light to a user of the display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display 120 may include additional modules and/or functionality such as audio output, image capture, location/position sensing. Other control(s) 126 may be employed to control such functionality (e.g., level and/or quality of audio output, image capture, location/position sensing, etc.), as well as functionality of the display 120 such as wireless remote control of the display 120.

In some examples, the display 120 may be an OLED, LCOS, or microLED type display. An OLED display may include a layer of organic materials situated between two electrodes, all deposited on a substrate. Varying conductivity levels of the organic molecules may be taken advantage of by applying different voltages to the electrodes and emitting light to project images. Thus, the display electronics 122 may include driving circuitry for each of the pixels.

OLED displays may be driven with active-matrix (AMOLED) control architecture. AMOLED control uses a TFT backplane to directly access and switch each individual pixel on or off, allowing for higher resolution and larger display sizes.

Based on their emission types, physical structures, etc., OLED displays may be divided into different types. Transparent OLED displays have only transparent components (substrate, cathode and anode) and, when turned off, are up to 85 percent as transparent as their substrate. When a transparent OLED display is turned on, it allows light to pass in both directions. White OLED displays emit white light that is brighter, more uniform and more energy efficient than that emitted by fluorescent lights. White OLEDs also have the true-color qualities of incandescent lighting. Bottom-emission OLED (BE-OLED) has a transparent anode fabricated on a glass substrate, and a shiny reflective cathode. Light is emitted from the transparent anode direction. Top-emission OLED (TE-OLED) has a substrate that is either opaque or reflective and is more suited to active-matrix design.

Stacked OLED displays use a pixel architecture that stacks the red, green, and blue subpixels on top of one another instead of next to one another, leading to substantial increase in gamut and color depth, and greatly reducing pixel gap. An Inverted OLED uses a bottom cathode that may be connected to the drain end of an n-channel TFT, in contrast to a conventional OLED, in which the anode is placed on the substrate. Foldable OLEDs have substrates made of very flexible metallic foils or plastics. Lightweight and durable, foldable OLEDs may be used in devices such as smart phones, tablets, and wearable devices. MicroOLED displays with no backlight, low power consumption, fast refresh rate, and wide operation temperature range, are considered to be the current state-of-the-art for wearable and near-eye display technologies.

As mentioned herein, analog driving circuitry is commonly used to generate desired gray level in activated pixels by applying different levels of voltages within a predefined range to the pixels depending on the content to be projected. Gray level of an LED display, also called the gradation or gray scale, refers to a brightness of individual LEDs. On a display, images are composed of pixels, which are comprised of one red, one green and one blue dot (LED). Each of these dots has its own brightness level, which can be converted to gray levels. Generally, the higher the gray level, the richer the displayed color, the finer and more detailed the picture. Common industry standards use 8-bit (eight different gray levels), but as technology advances, the gray level scale may become larger. Examples disclosed herein are directed to employing digital gray control, where a pulse width of the applied voltage may be varied, as opposed to amplitude, to generate the desired gray level in the activated pixels with the technical advantages discussed previously.

In some examples, the computing device 110 may provide content to the display 120 for presentation to the user through the input/output interface 140. The input/output interface 140 may facilitate data exchange between the computing device 110 and the display 120 through wired or wireless means (e.g., through radio frequency waves or optical waves) and include circuitry/devices to process exchanged data. For example, the input/output interface 140 may condition, transform, amplify, or filter signals exchanged between the computing device 110 and the display 120. The computing device 110 and/or the display 120 may include different or additional modules than those described in conjunction with FIG. 1. Functions further described herein may be distributed among components of the computing device 110 and the display 120 in a different manner than is described here.

FIG. 2 illustrates various display devices in diagram 200, according to an example. In some examples, the display 120 of FIG. 1 may be integrated with or communicatively coupled to a device such as laptop computer 202, desktop monitor 204, portable computer 206 (e.g., a tablet), wall-mount display 208, head-mount display 210, glasses 212, or smart watch 214.

In some examples, the display may be a part of a VR system, an augmented reality (AR) system, a mixed reality (MR) system, another system that uses displays or wearables, or any combination thereof.

In some examples, power consumption reduction as described herein may be more critical for battery or solar powered portable implementations. However, overall energy consumption reduction due to environmental concerns may be a consideration for all types of systems including devices that are directly powered by the electricity grid. Reduction of number of components and complexity of architecture is a technical advantage that applies to all types of displays. Furthermore, compatibility with standard CMOS scalability with future CMOS technology advances may also be desirable for different types of OLED display implementations.

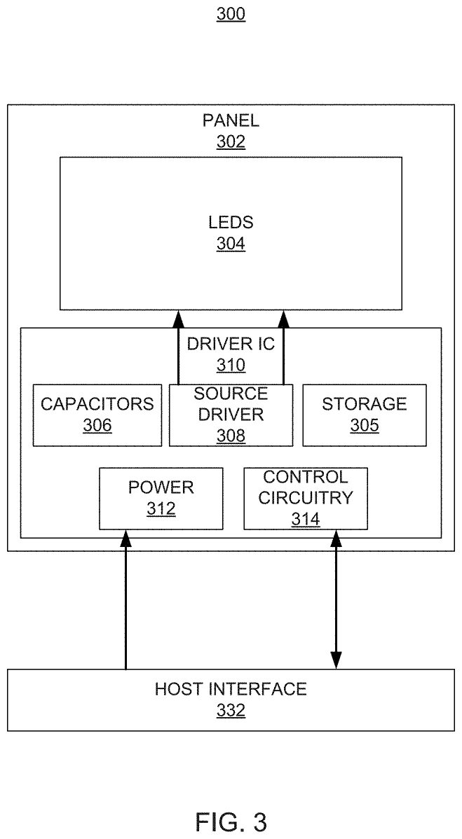

FIG. 3 is a block diagram of an OLED display 300, according to an example. In some examples, the display 300 may be a specific implementation of display 120 of FIG. 1 and may be configured to operate as a VR display, an AR display, and/or a MR display.

In some examples, the display 300 may include a panel 302 containing LEDs 304 and driver IC 310. In some examples, the display 300 may be configured to present media or other content to a user through controlled activation and emission of the LEDs 304. In some examples, the driver IC 310 may include electronics to perform functionality similar to those described with respect to FIGS. 1-2. The driver IC 310 may include, for example, source drive 308, capacitors 306, storage 305, power circuitry 312, and control circuitry 314. The panel 302 may be communicatively coupled (wired or wireless) to host interface 332. In some examples, the display 300 may also include any number of optical components, such as waveguides, gratings, lenses, mirrors, etc.

In some examples, source driver 308 may activate and control gray level of each pixel of the panel 302 using digital gray control. Drive circuitry for the LEDs 304 may include capacitors such as storage capacitors 306 in the driver IC 310. Driver IC 310 may further include data storage components 305 such as registers, flash memory, etc. Driver IC 310 may also include power supply circuitry 312 to provide various supply and reference voltages, currents to the other circuitry in the IC. Driver IC 310 may further include control circuitry 314 such as clock generators, comparators, and similar circuits to control functionality of the remaining components. In an example operation, the power supply circuitry 312 may receive power through the host interface 332 and generate needed voltages and currents. Similarly, control circuitry 413 may receive instruction signals and data through the host interface 332 and control functionality of the various components within the driver IC 310.

In some examples, digital gray control may be achieved through series-in and parallel-out data shift registers in columns and bit-weighted frequency clock lines and a local comparator (all in the driver IC 310) for each pixel. As the digital gray control allows use of advanced CMOS node, leveraging speed and smaller layout of advanced CMOS processes, source drivers may be implemented on a single IC using the same CMOS structure as the remaining circuitry. Furthermore, an output from driver IC 310 may be directly used in the backplane without DAC. In some examples, the driver IC 310 may be implemented as part of a thin film transistor (TFT) backplane driving the pixels directly. For example, low-temperature polycrystalline silicone (LTPS) TFTs are becoming increasingly common for OLED displays.

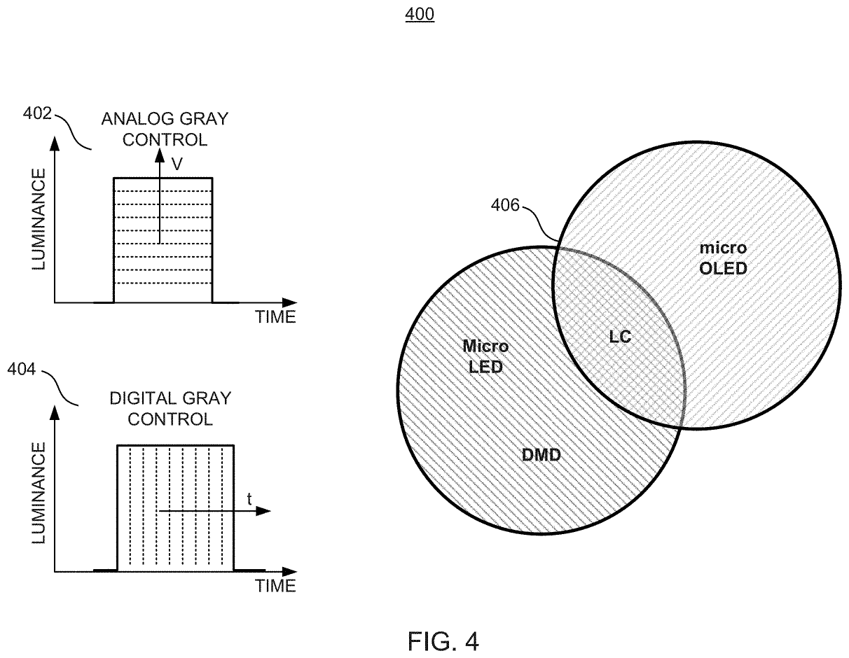

FIG. 4 illustrates a comparison of analog and digital gray control methods in various types of displays, according to an example. Diagram 400 in FIG. 4 includes graphic representations of analog gray control 402 and digital gray control 404, along with a Venn diagram 406 illustration of various display technologies using the different gray control methods.

As shown in Venn diagram 406, microLED, digital micro-mirror device, and some liquid crystal systems may utilize digital gray control, while microOLED technologies typically utilize analog gray control. Historically, analog gray control has been shown to operate in smart phone and smart watch applications for OLED displays with a TFT backplane and have been adopted in VR/AR/MR applications such as head-mounted displays and glasses.

As the luminance vs. time graph shows, analog gray control 402 utilizes different levels of voltage in the control device to achieve a desired gray level luminance. OLED pixels are current-driven emitter devices and require a current source from the backplane to provide the controllable current depending on the desired gray level of incoming content. The current control is achieved by applying different data voltages. An applicable voltage level is stored in a storage capacitor for each pixel and released during the emission phase.

In contrast with the analog gray control 402, digital gray control 404 may utilize pulse width modulation as shown in the luminance vs. time graph. Thus, a gray level of the corresponding pixel may be controlled by the duration of the applied current as opposed to an amplitude. This approach may eliminate the need for a storage capacitor and high voltage CMOS technology, as explained herein.

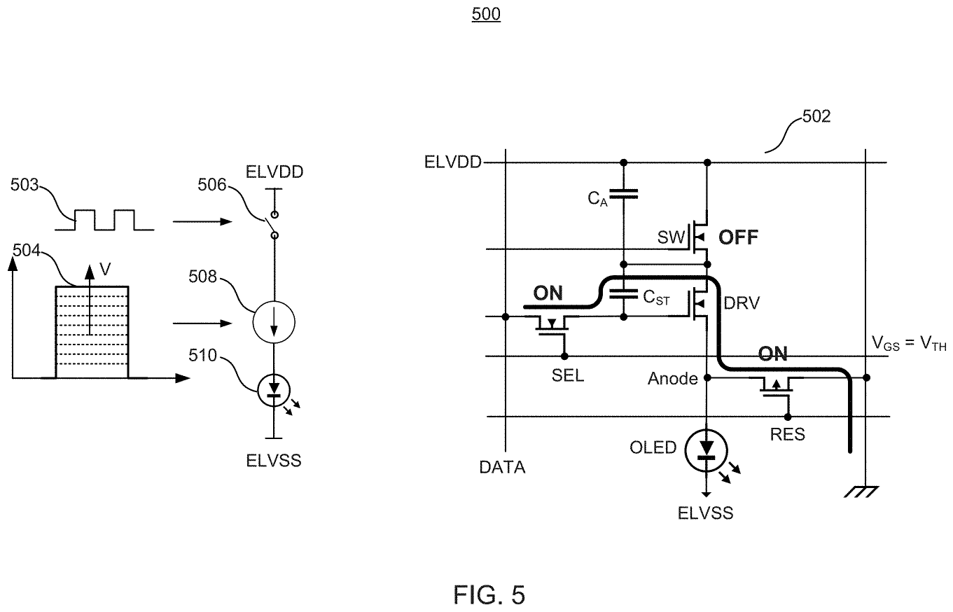

FIG. 5 illustrates pixel circuitry and operation of analog gray control for driving OLED display pixels, according to an example. In some examples, the pixel circuitry shown in diagram 500 may include an emission circuit that includes an emission transistor 506, a drive transistor 508, and an emissions diode (LED) 510. The emission transistor 506 may act as a switch and be controlled by a signal with fixed pulse width for all pixels. A variable data voltage 504 with fixed pulse width may be used to control the drive transistor 508 and determine current levels provided to the LED 510 based on an amplitude of the data voltage, thereby obtaining different levels of gray luminance. Schematic diagram 502 shows individual electronic components of an example pixel circuitry implementation.

In some examples, a selection transistor (SEL) and a reset transistor (RES) being turned on may allow the drive transistor (DRV) to be turned on, where storage capacitor (C_{ST}) may be used to store the data voltage level for that particular pixel determining a current level to be provided to the emission diode (OLED) and thereby the gray luminance. Thus, C_{ST} may be initialized based on the data voltage (V_{ref}) and discharged to sample the threshold voltage (V_{TH}). The emission transistor (SW) may be used to turn on and off the pixel (start and stop the emission phase) as discussed above.

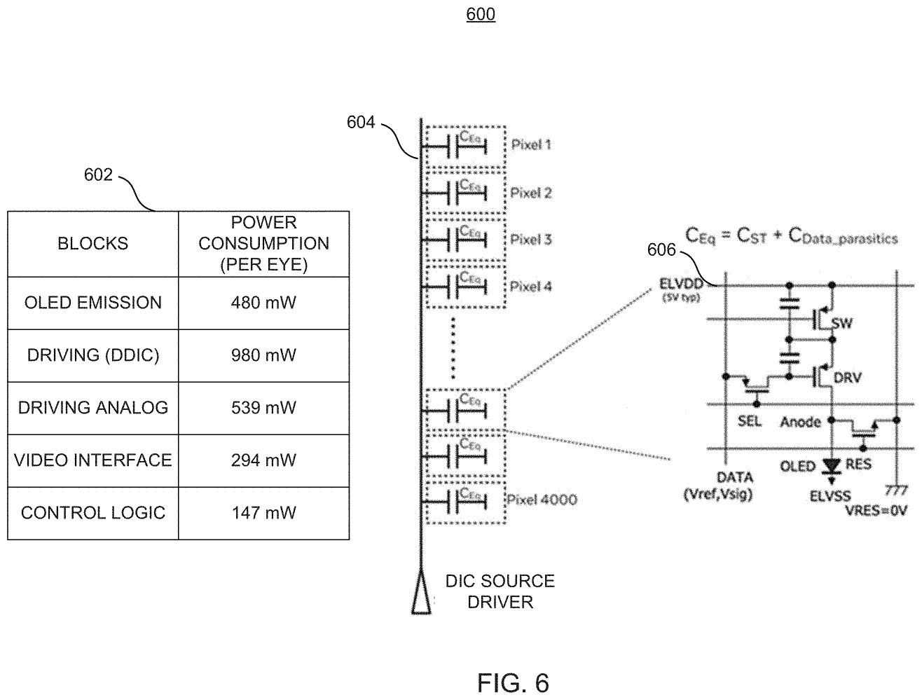

FIG. 6 illustrates schematic representation of capacitances associated with each pixel of and an example representation of power consumption components in an OLED display, according to an example. Diagram 600 in FIG. 6 includes schematic diagram 606, which shows the example pixel circuitry with individual components as in FIG. 5. Diagram 604 shows storage capacitors (C_{ST}) of all pixels in a display being coupled to a source driver of the driver IC to receive the data voltage. Table 602 shows example power consumptions of various operations in an example OLED display used in a VR application.

In some examples, an example OLED display with 4000×4000 pixels may have 16,000 C_{ST}s with 4,000 C_{ST}s coupled to each column. Thus, the source driver may have to charge (initialize) 4,000 C_{ST}s for each column. While the data voltage level may be low for some pixels, it may be at the maximum level of the range for others. Thus, a voltage swing to be accommodated by the driver may also need to meet the requirements of the data voltage for the OLED. The loading of the data line may therefore play a substantial role in overall power consumption because there is a storage capacitor connected to it at each pixel. When the data line changes the voltage from row to row depending on the content, the power consumed to charge the entire data line up to the desired voltage may be as much as 30% of the overall power consumption.

Furthermore, because sufficient data swing voltage is needed to achieve black to white, high output voltage transistors are preferred for analog gray control. Accurate voltage steps in data voltage may also be needed to achieve precise gray control, and a slow transistor's subthreshold swing is selected. Therefore, OLED displays commonly use specific high voltage CMOS processes and intentionally slow subthreshold swing transistors with process tuning or degenerated transistors. Both are nonstandard CMOS processes against the trend of CMOS technology scaling.

The incompatible CMOS structure needs of the analog architecture may add to complexity of driver ICs and overall OLED display manufacturing because the analog drivers may require a CMOS backplane that uses a customized transistor process while driver IC leverages transistors' speed in an advanced node. Thus, the display module may have a separate CMOS backplane, and the driver IC may be coupled to the backplane with a flex and bonding process. The additional production and assembly steps may add to the cost and reduce manufacturing throughput. Furthermore, even more power may be consumed to transfer the content between the driver IC and the backplane with the bonding pad and wiring delays.

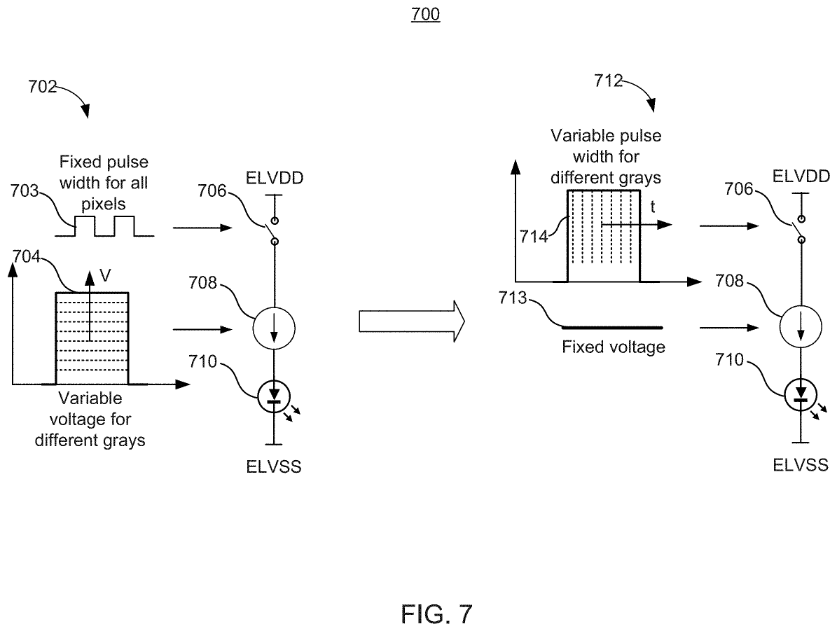

FIG. 7 illustrates a comparison of analog and digital gray control methods with respective pixel circuitry in OLED displays, according to an example. Diagram 700 include diagram 702, which shows pixel circuitry with an emission circuit that includes an emission transistor 706, a drive transistor 708, and an emission diode 710, where the emission transistor 706 may act as a switch controlled by a fixed pulse width signal for all pixels and the drive transistor 708 may be controlled by the variable data voltage for different gray levels. Diagram 712 shows pixel circuitry with an emission circuit that includes an emission transistor 716, a drive transistor 728, and an emission diode 720, where the emission transistor 706 may act as a switch controlled by a variable pulse width signal for different gray levels and the drive transistor 708 may be controlled by a fixed voltage.

In some examples, storage capacitor C_{ST} may be eliminated in the digital gray control OLED display because there is no need to store the data voltage levels for each pixel. Thus, in addition to complexity and cost savings through the removal of a capacitor for each pixel (e.g., 16,000 capacitors for a 4000×4000 pixel display), substantial power savings may be achieved in the digital gray control architecture by not having to drive the heavy data line. Furthermore, no DAC may be needed between the control circuitry and the driver.

In some examples, the digital gray control driver may not require high voltage transistor or to intentionally slow the subthreshold swing. Thus, the CMOS architecture of the drive circuitry may be compatible and scalable with standard CMOS architectures. As a result of the compatibility, the drive circuitry may be built into the backplane (e.g., CMOS backplane) removing the need for a separate IC coupled to the backplane through a flex cable, for example. The integration may result in further power savings for the OLED display.

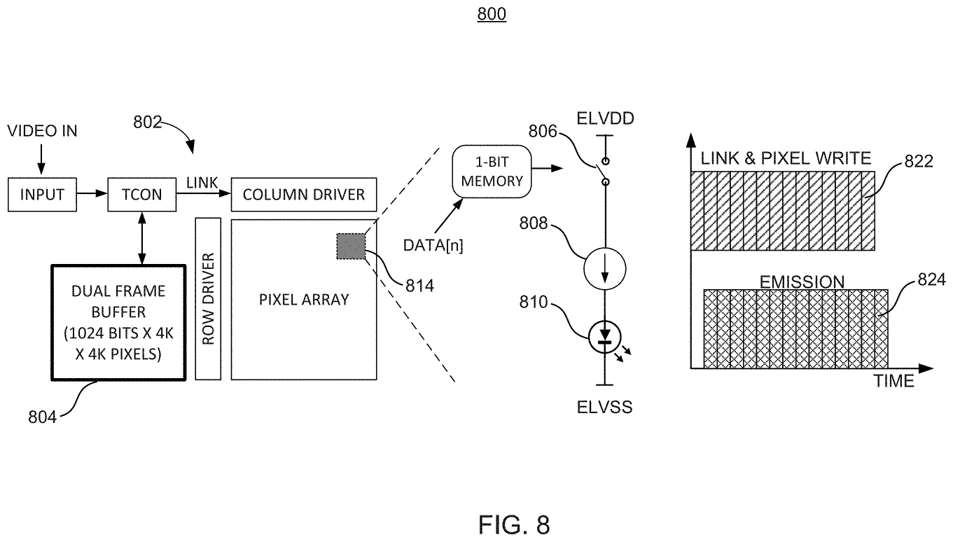

FIG. 8 illustrates a driver architecture to implement digital gray control through storage of gray level data for each pixel, according to an example. The architecture shown in diagram 800 is an example approach to using digital gray control in OLED displays. As shown in block diagram 802, the display electronics includes a pixel array with details of pixel 814 shown as an emission circuit that includes an emission transistor 806, a drive transistor 808, and an emission diode 810. The display electronics may further include an input circuit, a time controller, a column driver, and a row driver, among other components. The display electronics may also include a dual frame buffer 804 to store gray levels for each pixel.

In this conventional approach, 2\hat{ }N bits of data may need to be stored for each pixel, N being a number of gray levels and a number of bits for GPU compensation. For example, for 8 gray levels and 2 bits for GPU compensation, N would be 10 resulting in 1024 bits for each pixel. In an example OLED display of 4000×4000 pixels, a frame buffer of over 16 gigabits may be needed.

In addition to the needed large buffer, this “brute force” approach may suffer from high volume of data transfer (822) from driver IC to the backplane, where the bit-by-bit reading of data slows down operations (824) and may result indeed in increased power consumption. Thus, the “brute force” digital gray control approach is not a practical solution to the challenges of analog gray control.

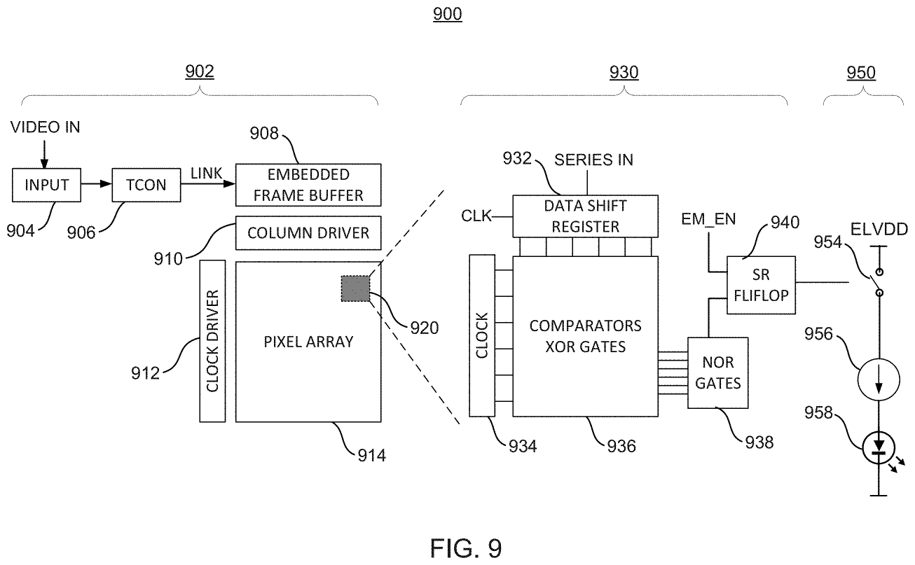

FIG. 9 illustrates a schematic block diagram of driver architecture for an OLED display pixel, according to an example. Diagram 900 includes block diagram 902 showing components of an example OLED display electronic with input circuitry 904, a timing controller 906, a frame buffer 908, a column driver 910, a clock driver 912, and a pixel array 914. Diagram 900 also includes schematic block diagram 930 showing control circuitry components such as data shift register 932, clock 934, comparators (XOR gates) 936, NOR gates sum circuit 938, and SR flipflop 940. Diagram 900 further shows schematic diagram 950 of pixel circuitry including an emission transistor 954, a drive transistor (current source) 956, and an emission diode 958.

In some examples, video (or images) may be provided to the input circuitry 904, which process the received data and provide to the timing controller 906. From there, the data may be provided to the frame buffer 908, which may accept data one row at a time. In some examples, due to its small size, the frame buffer 908 may be embedded into the IC as opposed to being a separate data storage component (e.g., a flash IC). The column driver 910 may provide data for each row to the respective columns of the pixel array 914 one row at a time controlled by the clock driver 912. An example pixel 920 of the pixel array 914 is shown with its controls and circuits in diagram 930.

In the example architecture, data may be fed to each row once and each pixel may have a local data shift register. Thus, a small frame buffer may be sufficient. For example, an 8×4000 frame buffer accommodating 8 bits of gray data for each column may be sufficient for a 4000×4000 example OLED display. In some examples, the small frame buffer may be embedded in the backplane. Thus, link power may be reduced. Furthermore, each pixel may have a digital comparator to convert to pulse width modulation. Therefore, a storage capacitor (C_{ST}) may not be needed resulting in substantial power and complexity savings.

As shown in diagram 930, data may be provided serially to the data shift register 932 and from there in parallel to the comparators 936. Serial or in-series transfer of data refers to transfer of data one bit at a time from one component to another, whereas parallel transfer of data refers to exchange of data between two components all at once. A comparator, also called binary comparator, digital comparator, or logic comparator, is a combinational logic circuit that is used to test whether a value represented by one binary word (or bit) is greater than, less than, or equal to the value represented by another binary word (bit). Comparators may be implemented in a variety of ways using different electronic components.

In some examples, comparators 936 may include XOR gates to compare clock driver input with data input. The XOR gates may provide a “0” output if data and clock input match, otherwise (if there is a mismatch) a “1” output. In some examples, the outputs of the XOR gates of comparators 936 may be provided to the NOR gates sum circuit 938 for a summing process, where an output of the NOR gates sum circuit may be “1” if all data and clock inputs match or “0” if at least one of them does not match. A “1” output (all match) from the NOR gates sum circuit 938 may set the SR (set-reset) flipflop 940, whereas a “0” output may reset the flipflop.

In some examples, when the SR flipflop 940 may be set based on an output of the NOR gates sum circuit 938, the emission transistor 954 may be turned on by the SR flipflop increasing a pulse width of the drive signal. A flip-flop, also referred to as a latch or bistable multivibrator, is a circuit that has two stable states and can be used to store state information. The circuit may be made to change state by signals applied to one or more control inputs and may have one or two outputs. As fundamental building blocks of digital electronics systems used in computers, communications, and many other types of systems, flip flops are used as data storage elements. One of the two states of a flip flop represents a “1” and the other represents a “0”. Flip flops may be divided into common types: the set-reset (“SR”), data (“D”), toggle (“T”), and JK. The behavior of a particular type of flip flop may be described by its characteristic equation, which derives the next (i.e., after the next clock pulse) output in terms of the input signal(s) and/or the current output. When the SR flipflop is reset, the emission transistor may be turned off by the SR flipflop decreasing the pulse width. The NOR gates sum circuit 938 may provide a “1” output to the SR flipflop 940 if all comparators match, “0” output if there is a mismatch in the data. Once all data match (“1” output from NOR gates sum circuit 938), the data shift register 932 may move on to next row.

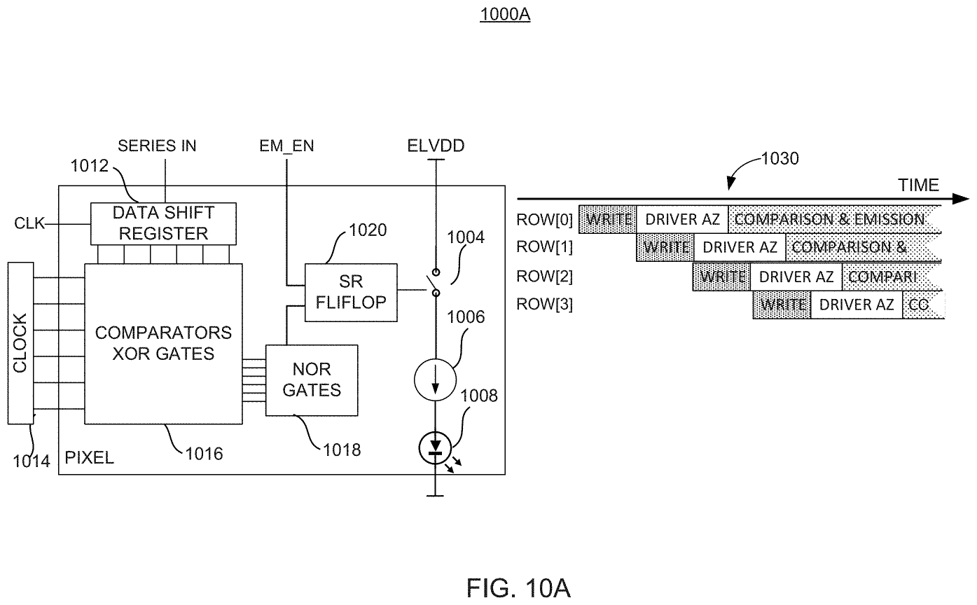

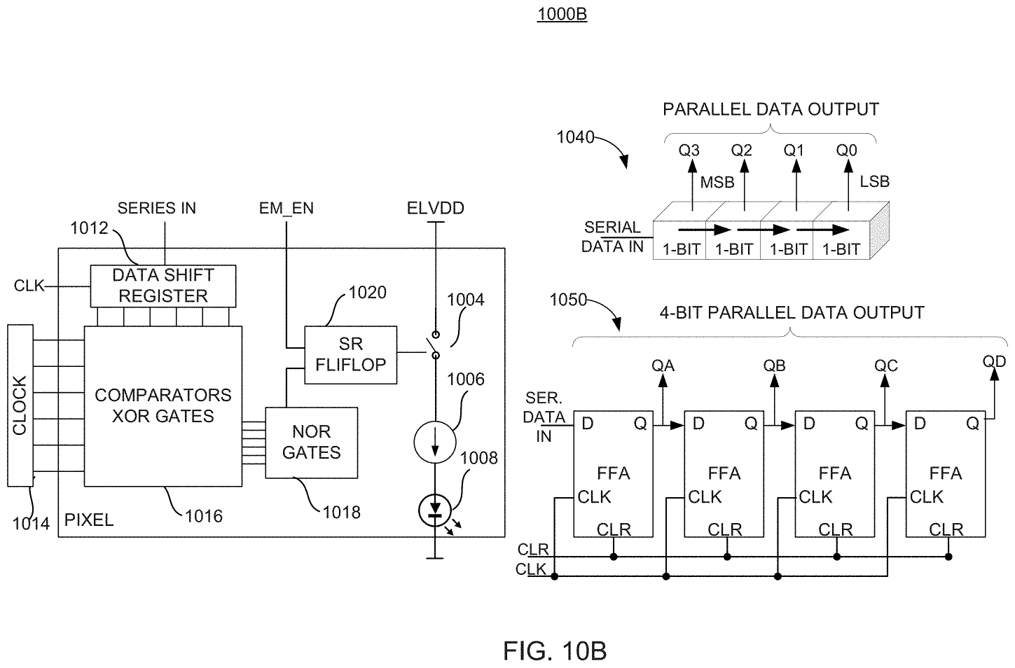

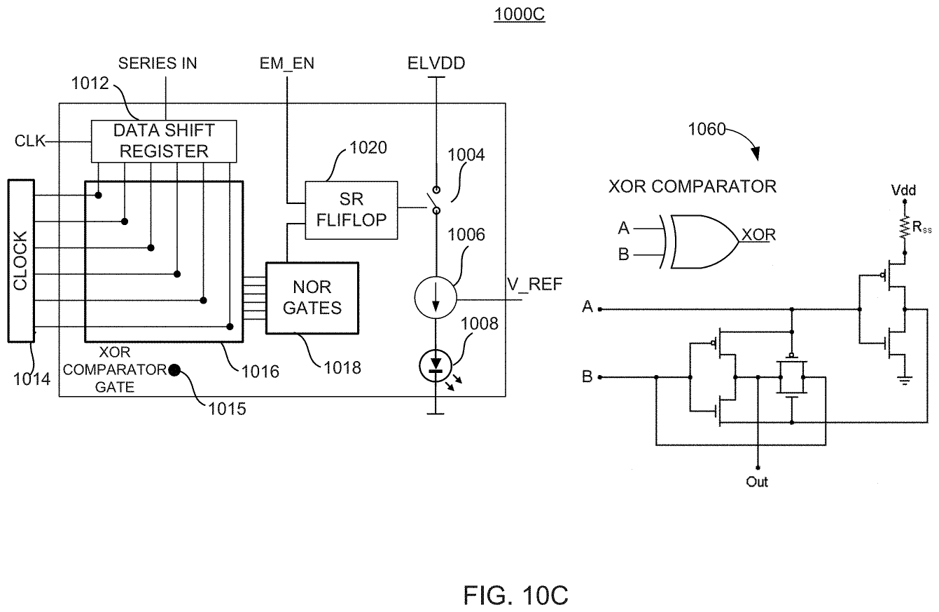

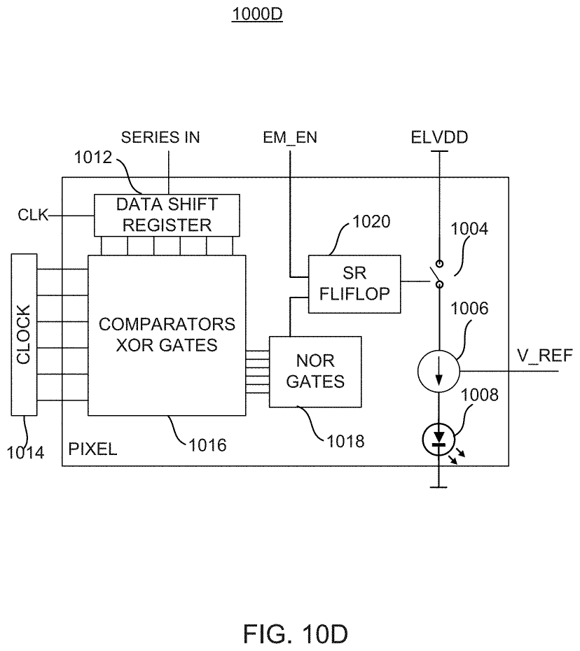

FIG. 10A illustrates a first stage of pixel operation in an OLED display, where data is provided serially to a pixel shift register, according to an example. Diagram 1000A shows local pixel circuitry including data shift register 1012, clock driver 1014, comparators 1016, NOR gates sum circuit 1018, SR flip flop 1020, emission transistor 1004, drive transistor 1006, and emission diode 1008. The diagram also includes an illustration of data writing process 1030 by rows.

As discussed in FIG. 9, the comparators 1016 may be implemented as XOR gates (one gate for each register bit). In some examples, the SR flip flop 1020 may take an output of the NOR gates sum circuit 1018 and may turn the emission transistor on or off based on the input effectively determining a pulse width of the emission. Data may be provided for each row bit-by-bit serially and stored in the local data shift register 1012. In some examples, the data stored serially in the data shift register 1012 may be output in parallel for each pixel and compared to the clock input. If all data matches for the row, the SR flip flop may be reset and the emission stopped.

In some examples, the data writing process 1030 may begin with writing of data into the data shift register 1012 for the first row, followed by driver. Then, the data may be compared to the clock data received from a clock external to the pixel circuitry (but within a backplane of the display). The emission diode 1008 may emit while the comparison is performed. In some examples, writing of data for the subsequent row may begin shortly after writing of data for a current row is completed.

FIG. 10B illustrates a second stage of pixel operation in an OLED display, where data bits are moved from latch to latch during each clock cycle while data is being written to each row of pixels, according to an example. Diagram 1000B shows local pixel circuitry including data shift register 1012, clock driver 1014, comparators 1016, NOR gates sum circuit 1018, SR flip flop 1020, emission transistor 1004, drive transistor 1006, and emission diode 1008. The diagram also includes a conceptual illustration 1040 of serial-in, parallel-out data writing into the shift register and a schematic diagram 1050 of an example implementation of the data shift register 1012.

In some examples, each gray level bit of data may be serially input into local pixel data shift register 1012 while data is being written to each row. After each clock cycle, data bits may be moved from latch to latch and stored inside each latch as shown in illustration 1040. While the example shift register in illustration 1040 is shown having a 4-bit capacity, example implementations may store any suitable number of bits at the local shift register. For example, a practical OLED display implementation may include 8 gray level bits. In some examples, all gray level bits of data may be output in-parallel to the XOR gates during a comparator stage.

Illustration 1050 shows an example implementation of the data shift register 1012 using D flip flops. Data may be serially input one bit at a time during each clock cycle through the D inputs of the flip flops. As the first flip flop receives a bit, another bit stored in that flip flop may be pushed to the next flip flop, and so on. Once all flip flops (the data shift register) are loaded, all bits may be output in parallel through the Q-outputs (in this case to the comparators 1016) and a subsequent loading cycle may begin. As with illustration 1040, the example implementation of the data shift register 1012 in schematic illustration 1050 is shown with a 4-bit capacity, but example implementations may store any suitable number of bits at the local shift register.

FIG. 10C illustrates a third stage of pixel operation in an OLED display, where data is compared to clock bit by bit in XOR comparators and an enable output is provided to a set/reset flip flop circuit if there is full match, according to an example. Diagram 1000C shows local pixel circuitry including data shift register 1012, clock driver 1014, comparators 1016 with each comparator implemented as an XOR gate 1015, NOR gates sum circuit 1018, SR flip flop 1020, emission transistor 1004, drive transistor 1006, and emission diode 1008. The diagram also includes a schematic illustration 1060 of an example implementation of each XOR gate 1015 and corresponding truth table.

In some examples, each row may have N clock lines (N=number of gray level bits), and the clock lines may run at bit-weighted frequencies (e.g., the highest frequency being the LSB value and successive clock lines being half the frequency of the previous clock line). Data may be compared to clock data received from an external clock bit by bit and when all data and corresponding clock data match, NOR gates sum circuit 1018 may output a “1” value.

In some examples, the XOR gates 1015 may be implemented through a circuit shown in schematic illustration 1060, but examples are not limited to this particular implementation. Other suitable implementations of XOR gates may also be used. In the XOR comparators, if Data[n]=CLK[n], then XOR output=“0”; otherwise, XOR output=“1”. In the NOR gates sum circuit, a summing operation may be performed, where only when all Data [n]=CLK[n] (i.e., all XOR outputs=“0”), then NOR output is “1”, otherwise NOR output may stay as “0”.

FIG. 10D illustrates a fourth stage of pixel operation in an OLED display, where the set/reset flip flop circuit enables or disables the emission circuitry, according to an example. Diagram 1000D shows local pixel circuitry including data shift register 1012, clock driver 1014, comparators 1016, NOR gates sum circuit 1018, SR flip flop 1020, emission transistor 1004, drive transistor 1006, and emission diode 1008.

In some examples, an emission ENABLE signal EM_EN may be used to set the SR flip flop 1020 to start the emission. Once the data is matched with the clock data in the comparators 1016, NOR gates sum circuit 1018 may output changes to “1”, which may reset the SR flip flop 1020 and stop the emission by turning off the emission transistor 1004. Thus, the pixel may emit while the data is being written and compared and stop emission once match is confirmed.

In some examples, the reference voltage V_{REF} provided to the drive transistor 1006 may have a fixed value but may be settable to multiple voltage levels for different brightness bands.

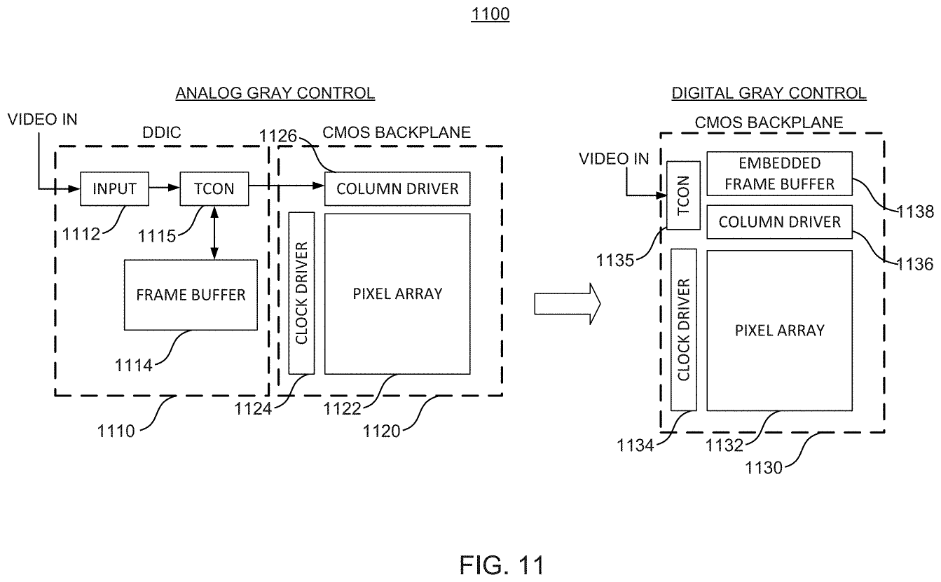

FIG. 11 illustrates an alternative implementation, where display driver integrated circuit (DDIC) may be integrated to the CMOS backplane of an OLED display, according to an example. Diagram 1100 shows an example analog gray control architecture, where the CMOS backplane 1120 including column driver 1126, pixel array 1122, and clock driver 1124, and the DDIC 1110 including input circuitry 112, timing controller 1115, and frame buffer 1114 may be distinctly implemented. Diagram 1100 also shows an example digital gray control architecture, where a single CMOS backplane 1130 may include a timing controller 1135, an embedded frame buffer 1138, a column driver 1136, a clock driver 1134, and a pixel array 1132.

Because of the different CMOS characteristic needs (e.g., higher voltage, slower subthreshold swing), the analog gray control architecture may require different DDIC and CMOS backplane, where the DDIC may be commonly manufactured as a discrete IC and coupled to the backplane. Digital gray control architecture, on the other hand, may utilize standard CMOS architecture. Thus, a full CMOS backplane 1130 may be used without a discrete driver IC simplifying components and manufacturing processes in addition to the power savings.

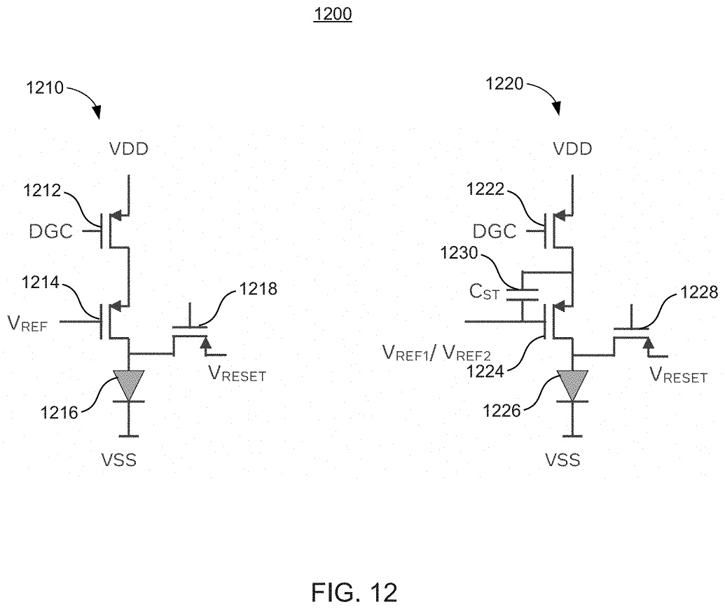

FIG. 12 illustrates another alternative implementation, where a storage capacitor may be added to each pixel's drive circuitry but used with low charge time interval to reduce power consumption, according to an example. Diagram 1200 shows a digital gray control drive circuit schematic 1210 with emission transistor 1212, drive transistor 1214, and emission diode 1216. Diagram 1200 also shows an alternative digital gray control drive circuit schematic 1220 with emission transistor 1222, drive transistor 1224, storage capacitor 1230, reset transistor 1228, and emission diode 1226.

In some examples, the digital gray control drive circuit 1210, as described in conjunction with FIG. 9 for example, may not include a storage capacitor because control voltage levels do not need to be stored. By removing the storage capacitor, in pixel threshold voltage V_{TH} compensation may also be removed. In some scenarios, this structure may result in vulnerability to driving transistor V_{TH} shift due to manufacturing process variations, temperature, and/or reliability issues.

In some examples, the driving transistor V_{TH} shift may be mitigated by using additional data bits for compensation. In other examples, V_{TH} compensation may be enabled by adding C_{ST} 1230 back to the pixel. To avoid losing the gain in power consumption, the C_{ST} 1230 may be charged at a very low time interval, substantially reducing an expected power consumption increase. For example, the C_{ST} 1230 may be charged once a week or once a few days depending on the V_{TH} shift of the drive transistor and usage time. Furthermore, V_{TH} may not need to be compensated every frame, unlike analog driving, because gray is controlled by emission pulse width as opposed to pulse amplitude.

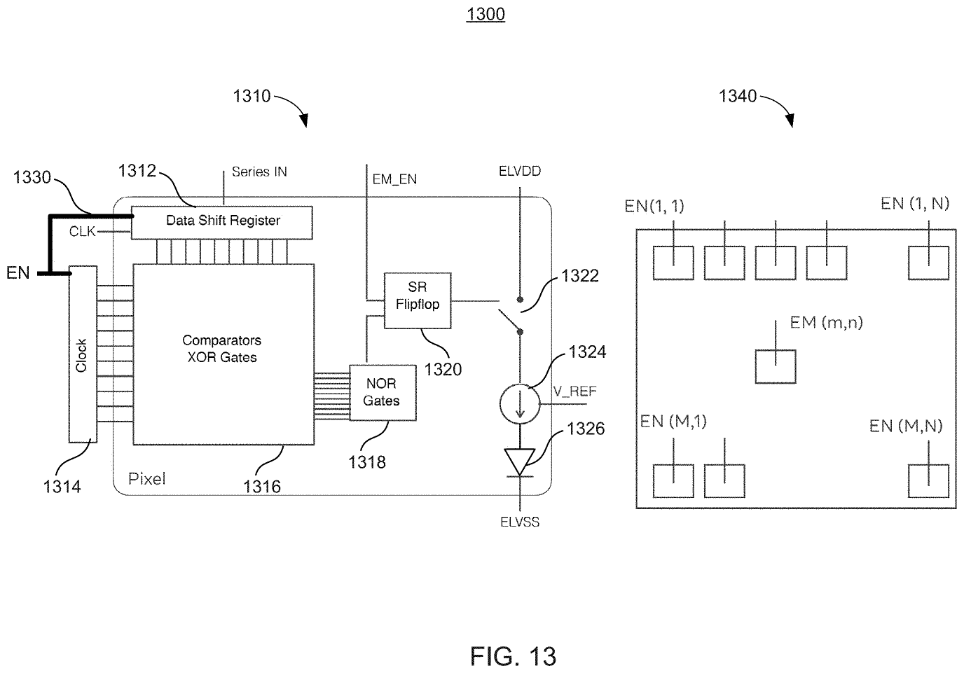

FIG. 13 illustrates a further alternative implementation, where an enable signal may control shift registers and clock generators of groups of pixels by disabling gray control of pixels with black content, according to an example. Diagram 1300 shows local pixel circuitry 1310 including data shift register 1316, clock driver 1314, comparators 1316, NOR gates sum circuit 1318, SR flip flop 1320, emission transistor 1322, drive transistor 1324, and emission diode 1326. Diagram 1300 also includes a representation 1340 of enable signals on a pixel.

In some examples, an enable signal EN 1330 may be added in both the data shift register 1316 and the clock driver 1314. Group(s) of pixels in the pixel array may share the dedicated enable signal EN 1330. Further power consumption reduction may be achieved in pixel emission pulse determination if a pixel is (or group of pixels are) black. For example, storage, comparison, and resulting drive circuit control may be avoided for pixels that are black through the enable signal EN 1330.

In some examples, the manufacturing process for the OLED display system may include providing a connection for the enable signal to the data shift register and the clock circuit of the display system to enable activation of one or more groups of pixels in the pixel array without black content. In other examples, the manufacturing process may include forming an OLED emission film that includes a substrate, an anode layer, a conductive layer, an emissive layer, and a cathode layer, where the OLED emission film includes emission diodes corresponding to the pixels of the pixel array and coupling the OLED emission film with a CMOS backplane that includes the remaining circuitry discussed herein. While examples are described herein may be directed to OLED displays, the various circuits, devices, and configurations associated with the systems, apparatuses, and methods described herein may also be implemented in LCD on silicon (LCOS), microLED, microOLED type displays, or any digital driving control display using the principles described herein.

According to some examples, a display system is described. An example display system may include control circuitry; power supply circuitry; and a pixel array. Each pixel in the pixel array may include a data shift register to receive gray level data for the pixel in series and to output the gray level data in parallel; a plurality of comparators, each comparator of the plurality of comparators to receive one bit of data from the data shift register and one bit of clock data; a NOR gates sum circuit to provide a binary output based on outputs of all of the plurality of comparators; a flip flop circuit to provide a binary output based on the binary output of the NOR gates sum circuit; and an emissions circuit to emit light at a selected gray level based on the binary output of the flip flop circuit.

According to some examples, the emission circuit may include an emission transistor controlled by the binary output of the flip flop circuit; a drive transistor serially coupled to the emission transistor and to act as a current source; and an emission diode serially coupled to the drive transistor and to emit the light at the selected gray level. The display system may further include an embedded frame buffer to store gray level data for a row of pixels, where the embedded frame buffer is to provide the gray level data to the pixel array row by row.

According to some examples, the NOR gates sum circuit may provide a “1” output if outputs of all of the plurality of comparators indicate a match and a “0” output if at least one output of the plurality of comparators indicates a mismatch. The flip flop circuit may be a set-reset (SR) flip flop and may turn off an emission transistor of the emission circuit if the binary output of the NOR gates sum circuit is a “1” and turn on the emission transistor of the emission circuit if the binary output of the NOR gates sum circuit is a “0”. Each of the plurality of comparators may include an XOR gate and may provide a “0” output if the one bit of data from the data shift register and one bit of clock data from the external clock match and provide a “1” output if the one bit of data from the data shift register and one bit of clock data from the external clock mismatch.

According to some examples, the display system may be an organic light emitting diode (OLED) display system, a microLED, liquid-crystal on silicon (LCOS), or a digital driving control-based display system. The display system may also include a clock circuit to provide the clock data to the plurality of comparators of each pixel. The data shift register, the plurality of comparators, the NOR gates sum circuit, and the flip flop circuit may be integrated with circuits of the display system external to the pixel array in a single CMOS backplane. Each pixel in the pixel array may further include a storage capacitor coupled between a source terminal and a gate terminal of the drive transistor. The data shift register and a clock circuit of the display system providing the clock data may receive an enable signal to enable activation of one or more groups of pixels in the pixel array without black content.

According to some examples, a method to make a display system is described. An example method may include disposing one or more of control circuitry and power supply circuitry on a substrate; and disposing a pixel array including a plurality of pixels on the substrate. The pixel array may be disposed on the substrate by disposing a data shift register for each pixel on the substrate, where the data shift register may receive gray level data for that pixel in series and to output the gray level data in parallel; disposing a plurality of comparators for each pixel on the substrate, where each comparator of the plurality of comparators may receive one bit of data from the data shift register and one bit of clock data; and disposing a NOR gates sum circuit for each pixel on the substrate, where the NOR gates sum circuit may provide a binary output based on outputs of all of the plurality of comparators for that pixel. The pixel array may further be disposed on the substrate by disposing a flip flop circuit for each pixel on the substrate, where the flip flop circuit may provide a binary output based on the binary output of the NOR gates sum circuit; disposing an emission transistor for each pixel on the substrate, where the emission transistor may be controlled by the binary output of the flip flop circuit; and disposing a drive transistor serially coupled to the emission transistor for each pixel on the substrate, where the drive transistor may act as a current source.

According to some examples, the method may further include disposing an embedded frame buffer on the substrate, where the embedded frame buffer may store gray level data for a row of pixels and provide the gray level data to each pixel array row by row. The method may also include disposing a clock circuit on the substrate, where the clock circuit may provide the clock data to the plurality of comparators of each pixel. The method may also include providing a connection for an enable signal to the data shift register and a clock circuit of the display system to enable activation of one or more groups of pixels in the pixel array without black content; or disposing a storage capacitor for each pixel in the pixel array, where the storage capacitor may be coupled between a source terminal and a gate terminal of each drive transistor. The display system may be an organic light emitting diode (OLED) display system, and the method may further include forming an OLED emission film that includes a substrate, an anode layer, a conductive layer, an emissive layer, and a cathode layer, the OLED emission film including a plurality of emission diodes corresponding to the plurality of pixels; forming the one or more of control circuitry, the power supply circuitry, and the pixel array as a single CMOS backplane; and coupling the OLED emission film and the CMOS backplane.

According to some examples, a method to operate a digital driving control-based display system is described. An example method may include receiving gray level data at a data shift register for each pixel in a pixel array in series; outputting the gray level data from the data shift register in parallel; receiving one bit of the gray level data from the data shift register and one bit of clock data from a clock at each of a plurality of comparators; providing a comparison of the one bit of the gray level data and the one bit of clock data from a clock for each pixel to a NOR gates sum circuit; providing a binary output based on comparison outputs of all of the plurality of comparators for a pixel to a flip flop circuit; and providing a binary output from the flip flop circuit to control an emission transistor for the pixel based on the binary output of the NOR gates sum circuit, where the emission transistor may control activation of an emission circuit for the pixel.

According to some examples, the method may also include receiving the gray level data at the data shift register from an embedded frame buffer, where the embedded frame buffer may store the gray level data for a row of pixels and provide the gray level data to each pixel array row by row. The method may further include controlling the activation of the emission circuit for the pixel by turning on and off the emission transistor, where the emission transistor may be coupled in series with a driving transistor that acts as a current source for an emission diode. The method may also include receiving an enable signal at the data shift register and the clock to activate one or more groups of pixels in the pixel array without black content.

According to some examples, a non-transitory computer-readable storage medium may have an executable stored thereon, which when executed instructs a processor to perform the methods described herein.

Various circuits, devices, and systems are described herein using example components, configurations, and characteristics. The discussed components, configurations, and characteristics are not intended to be restrictive of example circuits, devices, and systems. Examples may be implemented with different components, configurations, and characteristics using the principles described herein.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

1. A display system, comprising:
control circuitry;
power supply circuitry; and
a pixel array, wherein each pixel in the pixel array comprises:
a data shift register to receive gray level data for the pixel in series and to output the gray level data in parallel;
a plurality of comparators, each comparator of the plurality of comparators to receive one bit of data from the data shift register and one bit of clock data;
a NOR gates sum circuit to provide a binary output based on outputs of all of the plurality of comparators;
a flip flop circuit to provide a binary output based on the binary output of the NOR gates sum circuit; and
an emissions circuit to emit light at a selected gray level based on the binary output of the flip flop circuit.

2. The display system of claim 1, wherein the emission circuit comprises:
an emission transistor controlled by the binary output of the flip flop circuit;
a drive transistor serially coupled to the emission transistor and to act as a current source; and
an emission diode serially coupled to the drive transistor and to emit the light at the selected gray level.

3. The display system of claim 1, further comprising:
an embedded frame buffer to store gray level data for a row of pixels, wherein the embedded frame buffer is to provide the gray level data to the pixel array row by row.

4. The display system of claim 1, wherein the NOR gates sum circuit is to:
provide a “1” output if outputs of all of the plurality of comparators indicate a match; and
provide a “0” output if at least one output of the plurality of comparators indicates a mismatch.

5. The display system of claim 1, wherein the flip flop circuit is a set-reset (SR) flip flop and to:
turn off an emission transistor of the emission circuit if the binary output of the NOR gates sum circuit is a “1”; and
turn on the emission transistor of the emission circuit if the binary output of the NOR gates sum circuit is a “0”.

6. The display system of claim 1, wherein each of the plurality of comparators comprises an XOR gate and is to:
provide a “0” output if the one bit of data from the data shift register and one bit of clock data from the external clock match; and
provide a “1” output if the one bit of data from the data shift register and one bit of clock data from the external clock mismatch.

7. The display system of claim 1, wherein the display system is an organic light emitting diode (OLED) display system, a microLED, liquid-crystal on silicon (LCOS), or a digital driving control-based display system.

8. The display system of claim 1, further comprising:
a clock circuit to provide the clock data to the plurality of comparators of each pixel.

9. The display system of claim 1, wherein the data shift register, the plurality of comparators, the NOR gates sum circuit, and the flip flop circuit are integrated with circuits of the display system external to the pixel array in a single CMOS backplane.

10. The display system of claim 1, wherein each pixel in the pixel array further comprises a storage capacitor coupled between a source terminal and a gate terminal of the drive transistor.

11. The display system of claim 1, wherein the data shift register and a clock circuit of the display system providing the clock data are to receive an enable signal to enable activation of one or more groups of pixels in the pixel array without black content.

12. A method to make a display system, the method comprising:
disposing one or more of control circuitry and power supply circuitry on a substrate; and
disposing a pixel array comprising a plurality of pixels on the substrate by:
disposing a data shift register for each pixel on the substrate, the data shift register to receive gray level data for that pixel in series and to output the gray level data in parallel;
disposing a plurality of comparators for each pixel on the substrate, each comparator of the plurality of comparators to receive one bit of data from the data shift register and one bit of clock data;
disposing a NOR gates sum circuit for each pixel on the substrate, the NOR gates sum circuit to provide a binary output based on outputs of all of the plurality of comparators for that pixel;
disposing a flip flop circuit for each pixel on the substrate, the flip flop circuit to provide a binary output based on the binary output of the NOR gates sum circuit;
disposing an emission transistor for each pixel on the substrate, the emission transistor controlled by the binary output of the flip flop circuit; and
disposing a drive transistor serially coupled to the emission transistor for each pixel on the substrate, the drive transistor to act as a current source.

13. The method of claim 12, further comprising:
disposing an embedded frame buffer on the substrate, the embedded frame buffer to store gray level data for a row of pixels provide the gray level data to each pixel array row by row.

14. The method of claim 12, further comprising:
disposing a clock circuit on the substrate, the clock circuit to provide the clock data to the plurality of comparators of each pixel.

15. The method of claim 12, further comprising:
providing a connection for an enable signal to the data shift register and a clock circuit of the display system to enable activation of one or more groups of pixels in the pixel array without black content; or
disposing a storage capacitor for each pixel in the pixel array, the storage capacitor coupled between a source terminal and a gate terminal of each drive transistor.

16. The method of claim 12, wherein the display system is an organic light emitting diode (OLED) display system, and the method further comprises:
forming an OLED emission film that includes a substrate, an anode layer, a conductive layer, an emissive layer, and a cathode layer, the OLED emission film including a plurality of emission diodes corresponding to the plurality of pixels;
forming the one or more of control circuitry, the power supply circuitry, and the pixel array as a single CMOS backplane; and
coupling the OLED emission film and the CMOS backplane.

17. A method to operate a digital driving control-based display system, the method comprising:
receiving gray level data at a data shift register for each pixel in a pixel array in series;
outputting the gray level data from the data shift register in parallel;
receiving one bit of the gray level data from the data shift register and one bit of clock data from a clock at each of a plurality of comparators;
providing a comparison of the one bit of the gray level data and the one bit of clock data from a clock for each pixel to a NOR gates sum circuit;
providing a binary output based on comparison outputs of all of the plurality of comparators for a pixel to a flip flop circuit; and
providing a binary output from the flip flop circuit to control an emission transistor for the pixel based on the binary output of the NOR gates sum circuit, wherein the emission transistor controls activation of an emission circuit for the pixel.

18. The method of claim 17, further comprising:
receiving the gray level data at the data shift register from an embedded frame buffer, wherein the embedded frame buffer is to store the gray level data for a row of pixels and to provide the gray level data to each pixel array row by row.

19. The method of claim 17, further comprising:
controlling the activation of the emission circuit for the pixel by turning on and off the emission transistor, wherein the emission transistor is coupled in series with a driving transistor that acts as a current source for an emission diode.

20. The method of claim 17, further comprising:
receiving an enable signal at the data shift register and the clock to activate one or more groups of pixels in the pixel array without black content.
